(19) United States
(12) Patent Application Publication
(10) Pub. No.: US 2025/0029494 A1
(43) Pub. Date: Jan. 23, 2025

(54) STORAGE MANAGEMENT SYSTEM

(71) Applicant: SAMSUNG ELECTRONICS CO., LTD., Suwon-si (KR)

(72) Inventor: JINWOOK LEE, Suwon-si (KR)

(21) Appl. No.: 18/439,339

(22) Filed: Feb. 12, 2024

(30) Foreign Application Priority Data
Jul. 20, 2023 (KR) 10-2023-0094739

(51) Int. Cl. G08G 1/14

(52) U.S. Cl. CPC G08G 1/148

(57) ABSTRACT

The present disclosure relates to storage management systems. An example storage management system includes a storage manager and a storage. The storage manager generates a storage management command based on location data of a car including information about a real-time location of the car and parking data including information about a parking place. The storage is inside the car and includes a nonvolatile memory device. The storage performs a memory management operation for preventing data loss of the nonvolatile memory device based on the storage management command.

### CROSS-REFERENCE TO RELATED APPLICATION

This application claims priority under 35 U.S.C. § 119 to Korean Patent Application No. 10-2023-0094739 filed on Jul. 20, 2023, in the Korean Intellectual Property Office, the disclosures of which are incorporated by reference herein in their entireties.

### BACKGROUND

A semiconductor memory is classified as a volatile memory, which loses data stored therein when a power is turned off, such as a static random access memory (SRAM) or a dynamic random access memory (DRAM) or a nonvolatile memory, which retains data stored therein even when a power is turned off, such as a flash memory, a phase-change RAM (PRAM), a magnetic RAM (MRAM), a resistive RAM (RRAM), or a ferroelectric RAM (FRAM).

A flash memory device may be a representative example of the nonvolatile memory device. The flash memory device is widely used as a medium for storing audio and image data of information devices such as a computer, a mobile phone, a smartphone, a personal digital assistant (PDA), a digital camera, a voice recorder, an MP3 player, a handheld PC, a game console, a facsimile, a scanner, and a printer. Nowadays, high-capacity, high-speed input/output, and low-power technologies for the nonvolatile memory device are actively studied to install the flash memory device in a mobile device such as a smartphone.

As the demand on a high-capacity nonvolatile memory device increases, in general, a multi-level cell (MLC) or multi-bit memory device that stores multiple bits per memory cell is used. In particular, in a self-driving car (or an autonomous car), as a level of autonomous driving becomes higher, the capacity of the solid state drive (SSD) may become higher.

Accordingly, various methods for preventing the deterioration of the solid state drive provided inside the self-driving car are desired.

### SUMMARY

The present disclosure relates to a storage management system for preventing storage deterioration by performing a memory management operation on storage inside a car.

In some implementations, a storage management system includes a storage manager that generates a storage management command based on location data of a car including information about a real-time location of the car and parking data including information about a parking place, and storage that is provided inside the car and includes a nonvolatile memory device, and the storage performs a memory management operation for preventing data loss of the nonvolatile memory device based on the storage management command.

In some implementations, a storage management system includes a storage manager that generates a storage management command based on location data of a car including information about a real-time location of the car and parking data including information about a parking place, and storage that is provided inside the car and includes a nonvolatile memory device. The parking place includes a first location and a second location. The storage manager sets a first parking region of the first location and a second parking region of the second location. Based on the communication signals, the storage manager generates a first storage management command when a location of the car is within the first parking region, and generates a second storage management command when the location of the car is within the second parking region. The storage performs a first memory management operation based on the first storage management command, and performs a second memory management operation based on the second storage management command.

In some implementations, a storage management system includes a storage manager that receives a telecommunication signal, to set a parking place based on the telecommunication signal and a driving condition of a car and generates parking data, and storage that includes a parking data storage space storing the parking data generated by the storage manager. The storage manager receives the parking data from the parking data storage space, and generates a storage management command based on the telecommunication signal and the parking data. The storage performs a memory management operation for preventing data loss based on the storage management command.

### BRIEF DESCRIPTION OF THE FIGURES

The above and other objects and features of the present disclosure will become apparent by describing in detail implementations thereof with reference to the accompanying drawings.

FIG. 1 is a diagram illustrating an example of a storage system embedded in a car.

FIG. 2 is a block diagram illustrating an example nonvolatile memory device of FIG. 1.

FIG. 3 is a circuit diagram illustrating an example memory block of FIG. 2.

FIGS. 4A to 4C are example graphs illustrating threshold voltage distributions when a memory cell illustrated in FIG. 3 is a single level cell.

FIG. 5 illustrates example graphs describing how threshold voltage distributions change over a parking time when a memory cell illustrated in FIG. 3 is a multi-level cell.

FIG. 6 is a diagram illustrating an example of a car storage management system.

FIG. 7 is a diagram illustrating an example of a car storage management system of FIG. 6.

FIG. 8 is a diagram illustrating an example of a telecommunicating module.

FIG. 9 is a diagram illustrating an example of a car receiving a satellite communication signal from a GNSS receiver of FIG. 8.

FIG. 10 is a diagram illustrating an example of a parking place setting module.

FIG. 11 is a diagram for describing an example of an operation of a driving data generating unit of FIG. 10.

FIG. 12 is a diagram for describing an example of an operation of a parking data generator of FIG. 10.

FIG. 13 is a diagram illustrating an example of a telecommunicating module.

FIG. 14 is a diagram illustrating an example of a car receiving a network communication signal by a network receiver of FIG. 13.

FIG. 15 is a diagram illustrating an example of a parking place setting module.

FIG. 16 is a diagram for describing an example of an operation of a parking data generator of FIG. 15.

FIG. 17 is a diagram illustrating an example of a management execution module of FIG. 7.

FIG. 18 is a diagram for describing an example of an operation of a parking radius setting unit of FIG. 17.

FIG. 19 is a diagram for describing an example of an operation of a parking radius setting unit of FIG. 17.

FIG. 20 is a diagram illustrating an example of a management execution module of FIG. 7.

FIG. 21 is a diagram illustrating an example of a management execution module of FIG. 7.

FIG. 22 is a diagram illustrating an example of storage of FIGS. 6 and 7.

FIG. 23 is a diagram for describing an example of a memory management operation according to a storage management command.

FIG. 24 is a diagram illustrating an example of storage of FIG. 22.

FIG. 25 is an example diagram for describing how a first memory management operation is performed depending on a first storage management command.

FIG. 26 is an example diagram for describing how a second memory management operation is performed depending on a second storage management command.

FIG. 27 is a diagram illustrating another example of a first memory management operation performed depending on a first storage management command.

FIG. 28 is a diagram illustrating another example of a second memory management operation performed depending on a second storage management command.

FIG. 29 is a diagram illustrating another example of a storage management system.

### DETAILED DESCRIPTION

As used herein, the term “device” or “unit” refers to any combination of software, firmware, and/or hardware configured to provide the functionality described herein. The software may be implemented, for example, as a software package, a code, and/or an instruction set or an instruction, and the hardware may be implemented, for example, with a hardwired circuit, a programmable circuit, a state machine circuit, and/or an assembly or a single or arbitrary combination of firmware that stores instructions executable by a programmable circuit.

Below, implementations of the present disclosure will be described in detail and clearly to such an extent that an ordinary one in the art easily carries out the present disclosure.

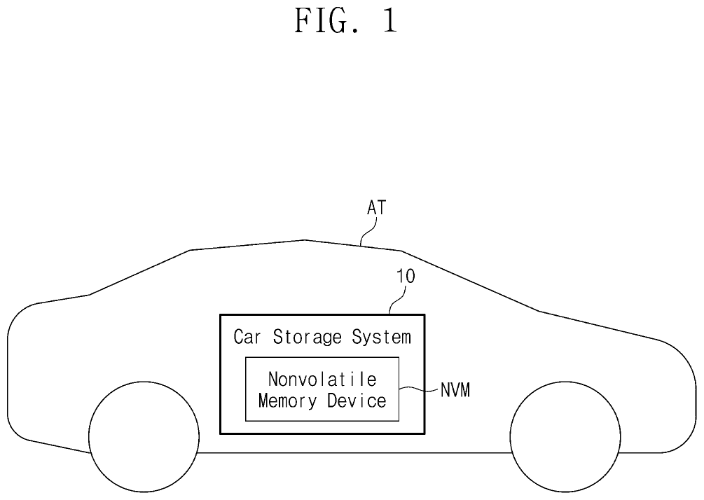

FIG. 1 is a diagram illustrating an example of a storage system embedded in a car.

Referring to FIG. 1, a car AT may include a storage system 10 therein. The storage system 10 may be configured to store various kinds of information such as driving information of the car AT, infotainment information of the car AT, and information about an operating system program of the car AT.

The storage system 10 may include a nonvolatile memory device NVM. For example, the nonvolatile memory device NVM may be implemented in the form of a solid state drive (SSD), an auto solid state drive (Auto SSD), a memory card, an embedded multi-media card (eMMC), or universal flash storage (UFS), but the present disclosure is not limited thereto.

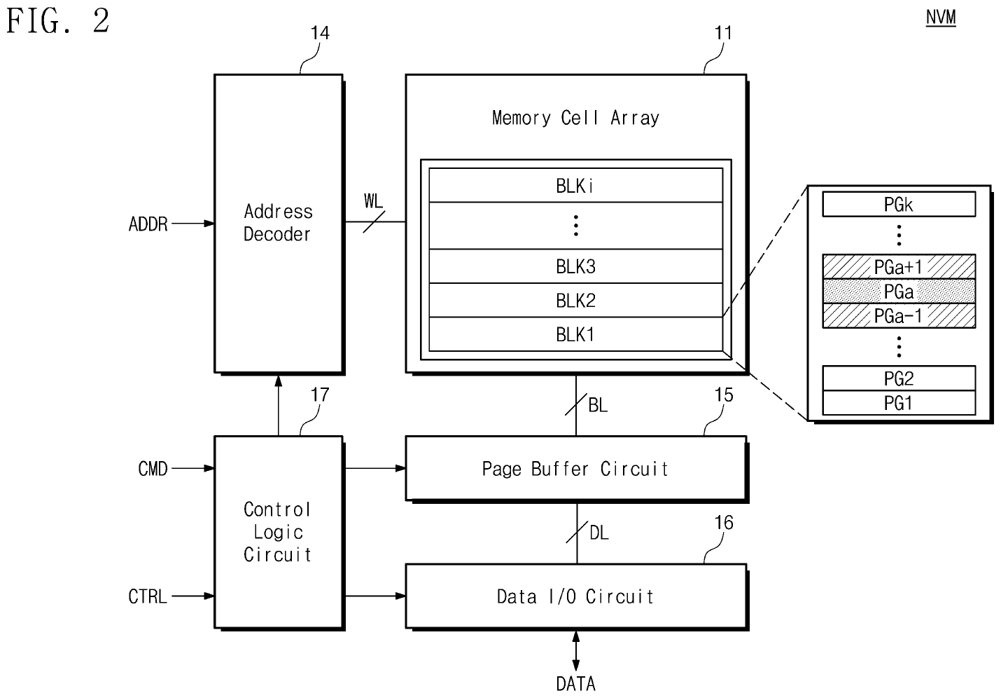

FIG. 2 is a block diagram illustrating an example nonvolatile memory device of FIG. 1.

Referring to FIG. 2, the nonvolatile memory device NVM may include a memory cell array 11, an address decoder 14, a page buffer circuit 15, a data input/output circuit 16, and a control logic circuit 17.

The memory cell array 11 may include a plurality of memory blocks. For example, the memory cell array 11 may include first to i-th memory blocks BLK1 to BLKi.

Each of the plurality of memory blocks BLK1 to BLKi includes a plurality of pages. As an example, the first memory block BLK1 may include first to k-th pages PG1 to PGk. The write operation and the read operation may be performed in the memory cell array 11 in units of page. The erase operation may be performed in units of memory block.

The memory cell array 11 is connected to the address decoder 14 through word lines WL or selection lines and is connected to the page buffer circuit 15 through bit lines BL. One page may be connected to one word line. A read voltage may be applied to a page targeted for the read operation, and a non-selection read voltage may be applied to the remaining pages in the same memory block. The non-selection read voltage that is a voltage for turning on the unselected pages may have a voltage level higher than that of the read voltage. Accordingly, when the non-selection read voltage is applied to the unselected pages, the amount of charges injected into memory cells included in the unselected pages may be affected by the interference.

As an example, when the read operation is performed with respect to the a-th page PGa, the non-selection read voltage may be applied to the first to (a−1)-th pages PG1 to PGa−1 and the (a+1)-th to k-th pages PGa+1 to PGk. In particular, when the read operation is repeatedly performed with respect to the a-th page PGa, the (a+1)-th page PGa+1 and the (a−1)-th page PGa−1 adjacent to the a-th page PGa may deteriorate due to the continuous interference caused by a potential difference between the read voltage and the non-selection read voltage.

The address decoder 14 is configured to decode an address ADDR received from a memory controller. The address decoder 14 may control voltages to be applied to the word lines WL based on the decoded address. As an example, the address decoder 14 may provide the read voltage targeted for the read operation and may provide the non-selection read voltage to the remaining pages.

The page buffer circuit 15 may operate as a write driver or a sense amplifier depending on an operation mode. In the write operation, the page buffer circuit 15 supplies a bit line voltage corresponding to write data to a bit line of the memory cell array 11. In the read operation, the page buffer circuit 15 senses data stored in a selected memory cell through a bit line.

In the write operation, the data input/output circuit 16 provides data “DATA” received from the memory controller to the page buffer circuit 15 through data lines DL. In the read operation, the data input/output circuit 16 receives the data “DATA” from the page buffer circuit 15 through the data lines DL. The data input/output circuit 16 may output the received data “DATA” to the memory controller.

The control logic circuit 17 controls the address decoder 14, the page buffer circuit 15, and the data input/output circuit 16 in response to a command CMD and a control signal CTRL received from the memory controller. The control logic circuit 17 may control the nonvolatile memory device NVM based on the command CMD such that the write operation, the read operation, or the erase operation is performed.

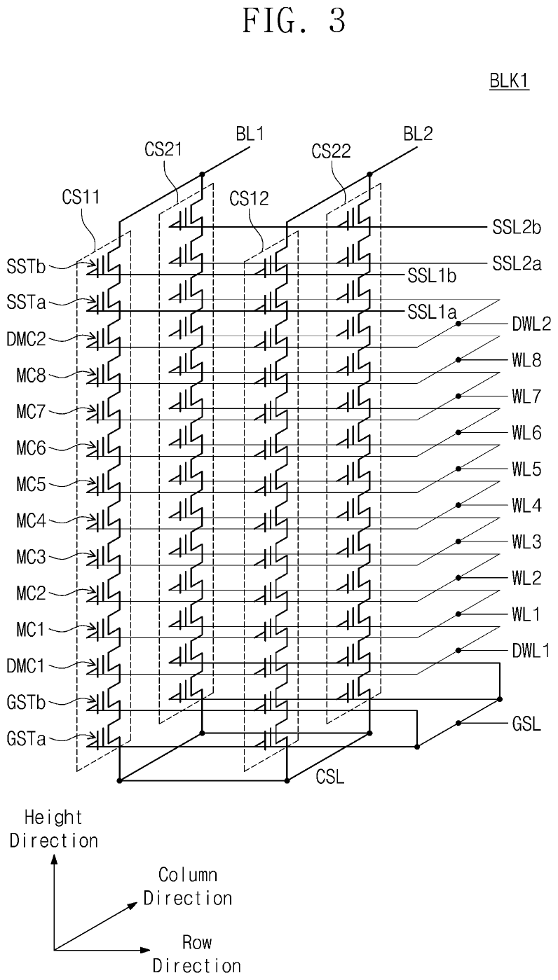

FIG. 3 is a circuit diagram illustrating an example memory block of FIG. 2.

The memory block BLK1 may be an arbitrary memory block included in the memory cell array 11 of FIG. 2. Referring to FIG. 3, a plurality of cell strings CS11, CS12, CS21, and CS22 may be arranged in a row direction and a column direction.

The cell strings CS11 to CS12 may be connected to string selection lines SSL1a and SSL1b and may form a first row. The cell strings CS21 to CS22 may be connected to string selection lines SSL2a and SSL2b and may form a second row. The cell strings CS11 to CS21 may be connected to a first bit line BL1 and may form a first column. The cell strings CS12 to CS22 may be connected to a second bit line BL2 and may form a second column.

Each of the cell strings CS11, CS12, CS21, and CS22 may include string selection transistors SSTa and SSTb, a plurality of memory cells MC1 to MC8, ground selection transistors GSTa and GSTb, and dummy memory cells DMC1 and DMC2. As an example, each of a plurality of cell transistors included in the cell strings CS11, CS12, CS21, and CS22 may be a charge trap flash (CTF) memory cell.

The plurality of memory cells MC1 to MC8 are serially connected and are stacked in a direction perpendicular to a plane defined by the row direction and the column direction, that is, in a height direction. The string selection transistors SSTa and SSTb are serially connected, and the serially connected string selection transistors SSTa and SSTb are interposed between the plurality of memory cells MC1 to MC8 and the bit lines BL1 and BL2. The ground selection transistors GSTa and GSTb are serially connected, and the serially connected ground selection transistors GSTa and GSTb are interposed between the plurality of memory cells MC1 to MC8 and a common source line CSL. In some implementations, the first dummy memory cells DMC1 may be interposed between the plurality of memory cells MC1 to MC8 and the ground selection transistors GSTa and GSTb. In some implementations, the second dummy memory cell DMC2 may be interposed between the plurality of memory cells MC1 to MC8 and the string selection transistors SSTa and SSTb.

The ground selection transistors GSTa and GSTb of the cell strings CS11, CS12, CS21, and CS22 may be connected in common with a ground selection line GSL. In some implementations, ground selection transistors in the same row may be connected to the same ground selection line, and ground selection transistors in different rows may be connected to different ground selection lines. For example, the first ground selection transistors GSTa of the cell strings CS11 and CS12 in the first row may be connected to a first ground selection line, and the first ground selection transistors GSTa of the cell strings CS21 and CS22 in the second row may be connected with a second ground selection line.

The read operation and the write operation of the memory block BLK1 may be performed in units of row, that is, page. For example, one row of the memory block BLK1 may be selected by the string selection lines SSL1a, SSL1b, SSL2a, and SSL2b. As a word line is driven, memory cells located at the same height from among memory cells of a selected row are selected. The read operation or the write operation may be performed with respect to the selected memory cells.

The erase operation may be performed in the memory block BLK1 in units of memory block. When the erase operation is performed in units of memory block, all the memory cells of the memory block BLK1 may be simultaneously erased based on one erase command. However, the present disclosure is not limited thereto. For example, some of the memory cells of the memory block BLK1 may be erased based on one erase command, and the others thereof may be erase inhibited.

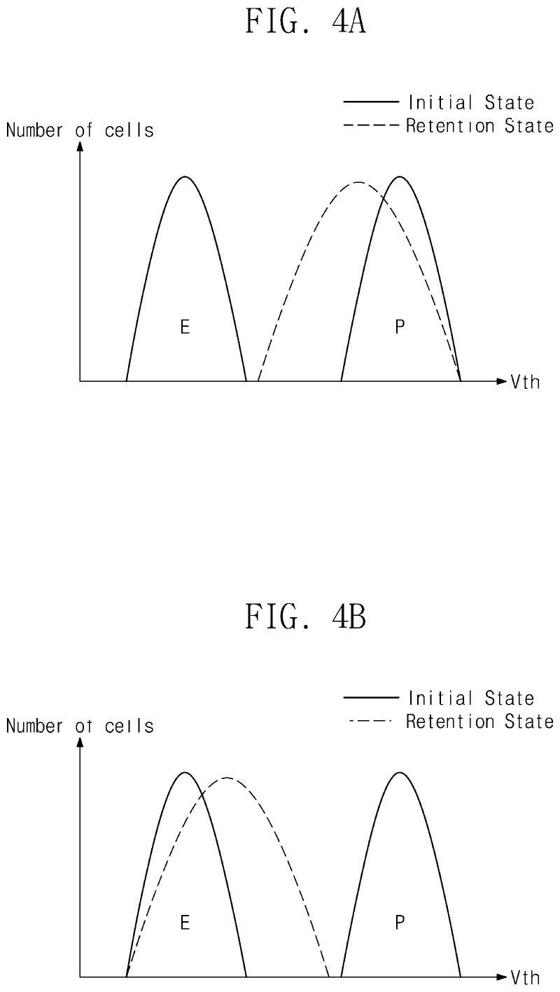

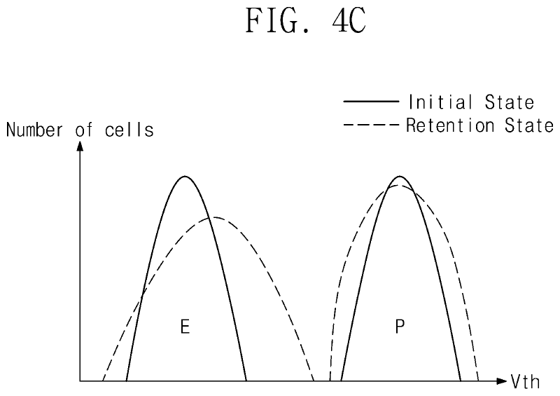

FIGS. 4A to 4C are example graphs illustrating threshold voltage distributions when a memory cell illustrated in FIG. 3 is a single level cell.

In FIGS. 4A to 4C, a horizontal axis represents a threshold voltage Vth of a memory cell, and a vertical axis represents the number of memory cells. A single level cell SLC has an erase state “E” or a program state “P” depending on a threshold voltage.

As the product including memory cells is used, the memory cells may deteriorate due to a temperature change, interference in the read operation, a long left-alone time; in this case, threshold voltage distributions of the memory cells may change.

In FIGS. 4A to 4C, a solid line shows an initial state of a threshold voltage distribution, and a dashed line shows how a threshold voltage distribution changes due to the deterioration of memory cells. In the initial state, the read margin between the erase state “E” and the program state “P” is sufficiently secured. However, when memory cells deteriorate, the read margin between neighboring program states may not be sufficiently secured.

For example, in the case of the flash memory, when an operating temperature increases, charges trapped in a memory cell may be leaked out; in this case, a threshold voltage distribution of the program state “P” may be deformed in a direction in which threshold voltages of the program state “P” decrease (refer to FIG. 4A).

In the case of the flash memory, when the number of read operations (or a read count) increases, charges may be trapped in a memory cell of the erase state “E” due to the read disturb; in this case, a threshold voltage distribution of the erase state “E” may be deformed in a direction in which threshold voltages of the erase state “E” increase (refer to FIG. 4B). Also, in the case of the flash memory, when the number of write operations (or a write count) increases, a tunnel oxide may deteriorate. In this case, a threshold voltage distribution of the erase state “E” may be deformed in a direction in which threshold voltages of the erase state “E” increase (refer to FIG. 4B).

FIG. 4C shows an example in which threshold voltage distributions of the erase state “E” and the program state “P” are deformed due to the deterioration of all memory cells. The above memory cell deterioration may occur when data are repeatedly written and erased, when data are repeatedly read, or when written data are left alone for a long time.

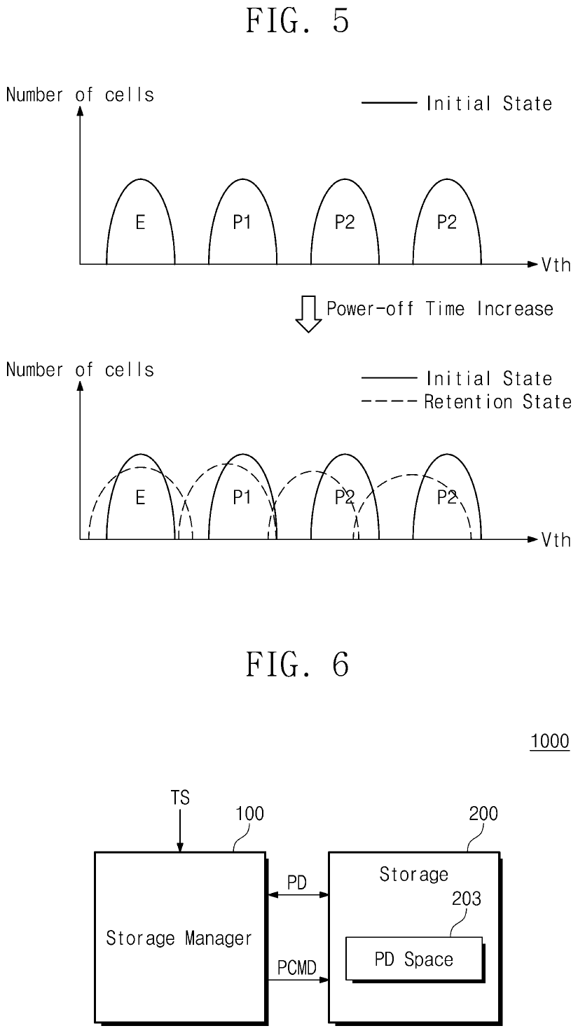

FIG. 5 illustrates example graphs describing how threshold voltage distributions change over a parking time when a memory cell illustrated in FIG. 3 is a multi-level cell.

Referring to FIG. 5, when a memory cell is a multi-level cell (MLC), the memory cell has one of four states “E”, P1, P2, and P3 depending on a threshold voltage. A solid line shows an initial state of a threshold voltage distribution, and a dashed line shows how a threshold voltage distribution changes due to the deterioration of memory cells.

In the initial state, the read margins may be sufficiently secured between the erase state “E” and the program states P1, P2, and P3.

However, as described above, as the product including memory cells is used, threshold voltage distributions of the memory cells may change due to the memory cell deterioration. For example, as a parking time increases in a state where a power of a car is turned off, the memory cells of the product installed in the car may deteriorate; in this case, the read margin between neighboring program states may not be sufficiently secured.

The present disclosure relates to a car storage management system that performs a memory management operation such that there is alleviated the deterioration of memory cells over a parking time in a state where a power of a car is turned off.

FIG. 6 is a diagram illustrating an example of a car storage management system.

Referring to FIG. 6, a car storage management system 1000 may include a storage manager 100 and storage 200. The storage 200 may mean a storage medium provided inside a car, and the storage manager 100 may be provided inside the car to manage the storage 200.

The storage manager 100 may be configured to receive a telecommunication signal TS. The storage manager 100 may be configured to set a parking place (or parking space or spot) based on the telecommunication signal TS and a driving condition of the car and to generate parking data PD. The parking data PD may include information about the parking place.

The storage 200 may include a nonvolatile memory device. For example, the nonvolatile memory device may be implemented in the form of a solid state drive (SSD), an auto solid state drive (Auto SSD), a memory card, an embedded multi-media card (eMMC), or universal flash storage (UFS), but the present disclosure is not limited thereto.

The storage 200 may include a parking data storage space 203. The parking data storage space 203 may be configured to store the parking data PD generated by the storage manager 100. For example, the storage 200 may utilize a specific memory block of the nonvolatile memory device as the parking data storage space 203.

The storage manager 100 may be configured to receive the parking data PD from the parking data storage space 203 of the storage 200. The storage manager 100 may be configured to generate a storage management command PCMD based on the telecommunication signal TS and the received parking data PD. The storage management command PCMD generated by the storage manager 100 may be provided to the storage 200.

The storage 200 may be configured to perform the memory management operation based on the storage management command PCMD. The memory management operation may include various operations capable of preventing the nonvolatile memory device from losing data. For example, the memory management operation may include a data refresh operation, a wear leveling operation, a garbage collection operation, etc.

According to some implementations of the present disclosure, when a car approaches a parking place, the memory management operation may be performed before the start turns off, and thus, the deterioration of memory cells may be prevented or alleviated.

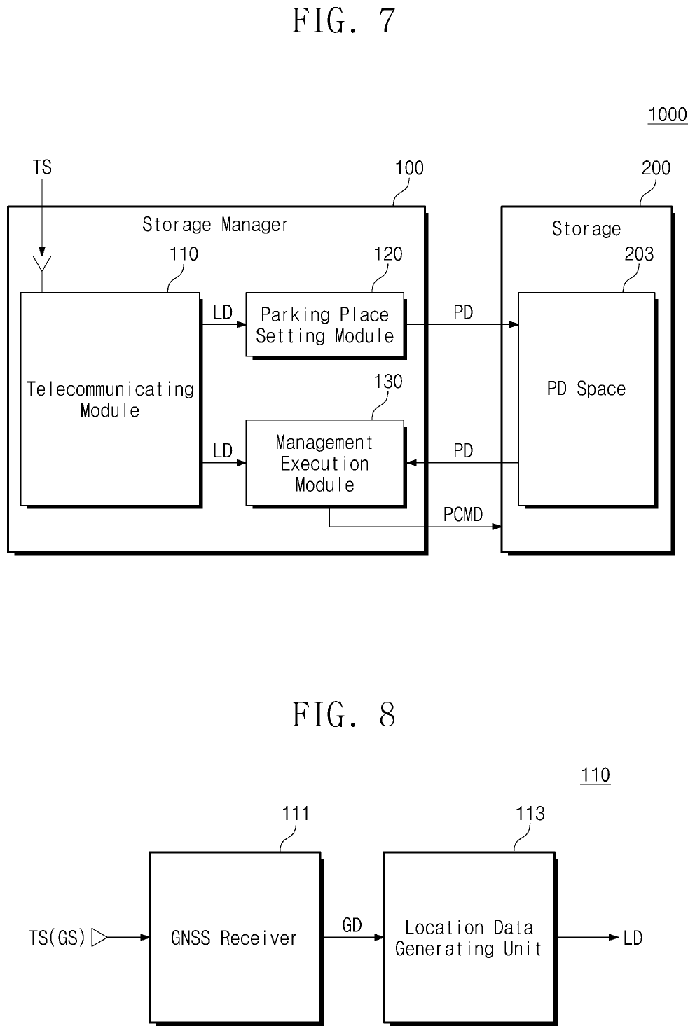

FIG. 7 is a diagram illustrating an example of a car storage management system of FIG. 6.

Referring to FIG. 7, the storage manager 100 may include a telecommunicating module 110, a parking place setting module 120, and a management execution module 130. For example, the storage manager 100 may include a telemetics control unit (TCU) that controls the storage 200 based on driving information and location information of the car.

The telecommunicating module 110 may be configured to receive the telecommunication signal TS from the outside of the car. The telecommunication signal TS may include information for determining the location of the car. For example, the telecommunication signal TS may include a satellite communication signal, a network communication signal. For example, the satellite communication signal that is a signal using the global navigation satellite system (GNSS) may include a signal complying with the GNSS, GPS, GLONASS, Galileo, or BeiDou standard. For example, the network communication signal may include a Wi-Fi signal and a wireless communication network signal for exchanging data with the car.

The telecommunicating module 110 may be configured to generate location data LD of the car, which includes real-time location information of the car, based on the telecommunication signal TS. In the specification, the location data LD of the car indicating the location of the car and/or location information about a specific place may mean satellite communication information (e.g., latitude information and longitude information), but the present disclosure is not limited thereto. For example, various information capable of determining a specific location may be included therein. The location data LD of the car generated by the telecommunicating module 110 may be provided to the parking place setting module 120 and the management execution module 130.

The parking place setting module 120 may be configured to determine a parking place based on the location data LD of the car and to generate the parking data PD. The parking data PD may include location information about a place determined as a parking place. The parking place may include a plurality of parking places, and the parking data PD may include location information for the respective parking places.

In some implementations, the parking place setting module 120 may be configured to determine a parking place based on satellite communication information, a driving condition of a car, and a parking time of a car. Below, how the parking place setting module 120 determines a parking place based on satellite communication information, a driving condition, and a parking time of a car will be described in detail with reference to FIGS. 8 to 12.

In some implementations, the parking place setting module 120 may be configured to determine a parking place based on satellite communication information, network information, and a parking time. Below, how the parking place setting module 120 determines a parking place based on satellite communication information, network information, and a parking time of a car will be described in detail with reference to FIGS. 13 to 16.

The parking data PD generated by the parking place setting module 120 may be provided to the storage 200.

The storage 200 may include the parking data storage space 203. The parking data storage space 203 may be configured to store the parking data PD generated by the parking place setting module 120.

For example, the storage 200 may include a nonvolatile memory device and a memory controller. The nonvolatile memory device may include the parking data storage space 203, and the memory controller may be configured to control the nonvolatile memory device. The storage manager 100 may store the parking data PD in the parking data storage space 203 of the nonvolatile memory device through the memory controller or may receive the parking data PD from the parking data storage space 203 of the nonvolatile memory device through the memory controller.

The management execution module 130 may be configured to receive the location data LD of the car from the telecommunicating module 110 and to receive the parking data PD from the storage 200. The management execution module 130 may be configured to generate the storage management command PCMD based on the location data LD of the car and the parking data PD such that the storage 200 performs the management operation. Below, how the management execution module 130 generates the storage management command PCMD will be described in detail with reference to FIGS. 17 to 21.

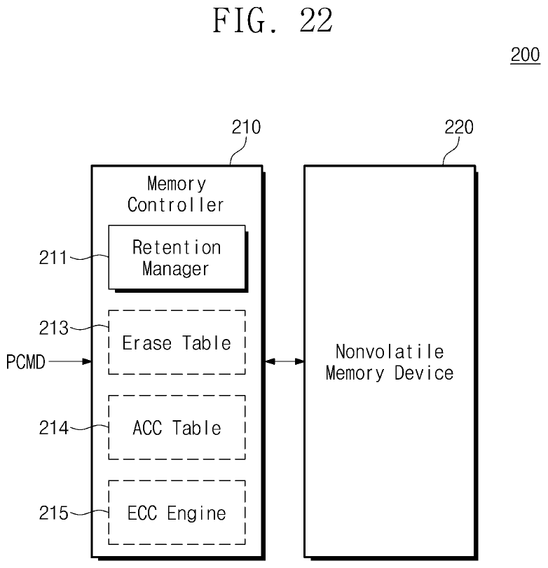

The storage 200 may be configured to receive a management command. The storage 200 may be configured to perform the memory management operation based on the management command. Below, how the storage 200 performs the memory management operation will be described in detail with reference to FIGS. 22 to 26.

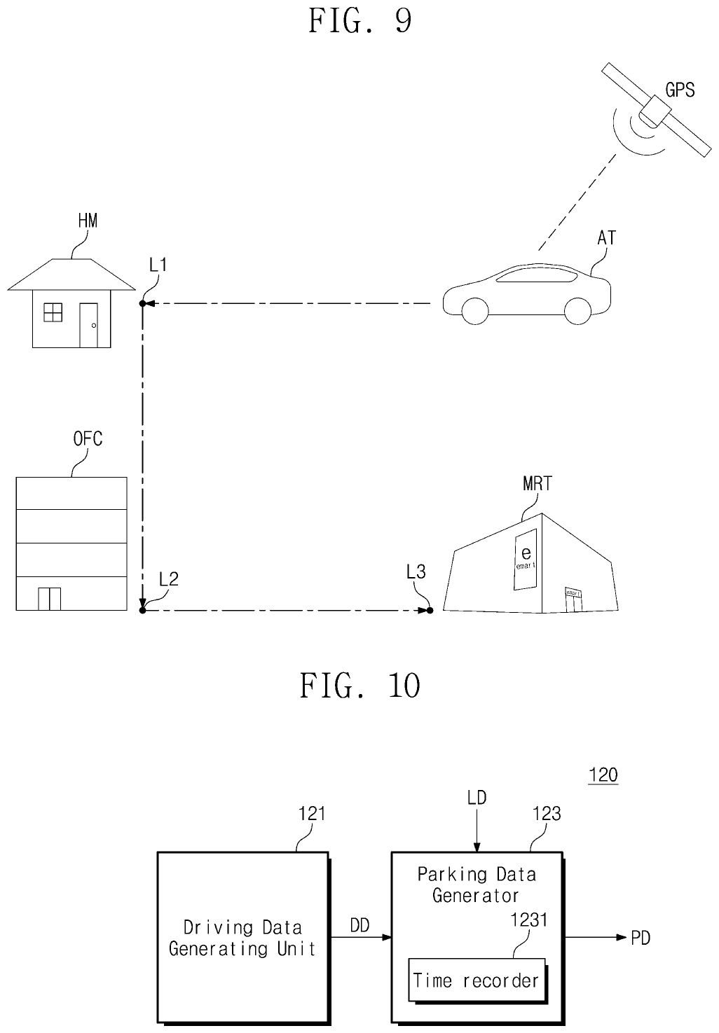

FIG. 8 is a diagram illustrating an example of a telecommunicating module. FIG. 9 is a diagram illustrating an example of a car receiving a satellite communication signal from a GNSS receiver of FIG. 8. Below, the telecommunicating module will be described with reference to FIG. 7 together.

Referring to FIGS. 7 and 8, the telecommunicating module 110 may include a GNSS receiver 111 and a location data generating unit 113.

The GNSS receiver 111 may be configured to receive a satellite communication signal from the satellite. For example, the satellite communication signal may be a GNSS signal. The GNSS receiver 111 may be configured to transfer satellite information GD of the car based on the satellite communication signal.

The location data generating unit 113 may be configured to generate the location data LD of the car including real-time location information of the car based on the satellite information GD. For example, the location data LD of the car may include latitude information and longitude information of the car.

Referring to FIG. 9 together, the car may sequentially move to a first location L1, a second location L2, and a third location L3 while receiving the satellite communication signal from the satellite. The first location L1 may be a parking place near the home of the car driver, the second location L2 may be a parking place near the office of the car driver, and the third location L3 may be a parking place near a mart that the car driver uses.

As the car moves to the first to third locations L1, L2, and L3, the telecommunicating module 110 may determine the real-time location of the car based on the satellite communication signal from the satellite and may generate the location data LD of the car. For example, when the car arrives at the first location L1, the telecommunicating module 110 may generate the location data LD of the car including latitude information and longitude information of the first location L1. For example, when the car arrives at the second location L2, the telecommunicating module 110 may generate the location data LD of the car including latitude information and longitude information of the second location L2. For example, when the car arrives at the third location L3, the telecommunicating module 110 may generate the location data LD of the car including latitude information and longitude information of the third location L3.

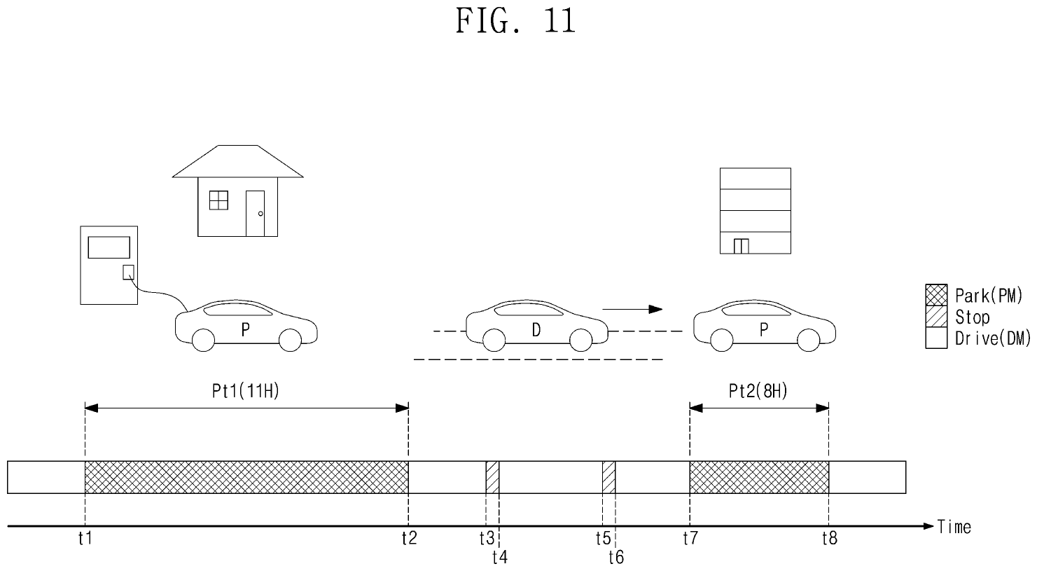

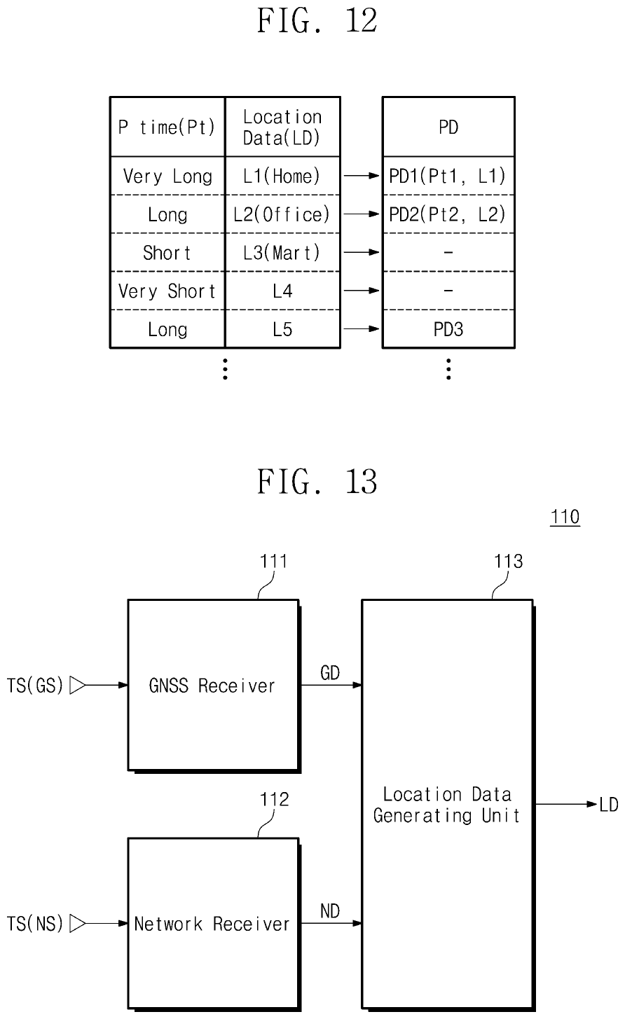

FIG. 10 is a diagram illustrating an example of a parking place setting module. FIG. 11 is a diagram for describing an example of an operation of a driving data generating unit of FIG. 10. FIG. 12 is a diagram for describing an example of an operation of a parking data generator of FIG. 10. Below, a parking place setting module will be described with reference to FIG. 7 together.

Referring to FIGS. 7 and 10, the parking place setting module 120 may include a driving data generating unit 121 and a parking data generator 123.

The driving data generating unit 121 may be configured to determine a driving condition of the car and to generate driving data DD. The driving condition of the car may correspond to one of a parking state, a driving state, and a stop state.

In some implementations, the driving data generating unit 121 may determine the driving condition of the car based on the setting of the gear transmission of the car. For example, when the gear transmission of the car is set to a parking mode PM, the driving data generating unit 121 may determine that the car is in the parking state. For example, when the gear transmission of the car is set to a drive mode DM, the driving data generating unit 121 may determine that the car is in the driving state. For example, when the car briefly stops due to the braking operation in a state where the gear transmission of the car is set to the drive mode DM, the driving data generating unit 121 may determine that the car is in the stop state.

In some implementations, the driving data generating unit 121 may determine the driving condition based on a turn-on state or a turn-off state of the start of the car.

The parking data generator 123 may be configured to receive the driving data DD from the driving data generating unit 121 and to receive the location data LD of the car from the telecommunicating module 110. The parking data generator 123 may be configured to determine a parking time at a place, in which the car is in the parking state, based on the driving data DD and the location data LD of the car and to generate the parking data PD. In some implementations, the parking data PD may include latitude information, longitude information, and a parking time for each of a plurality of parking places.

The parking data generator 123 may include a time recorder 1231 configured to measure a parking time of the car. The time recorder 1231 may be configured to measure a parking time based on driving data of the car.

In some implementations, the time recorder 1231 may measure, as a parking time, an elapsed time from a start point in time of the parking state of the car (i.e., a point in time when the gear transmission is set to the parking mode PM) to an end point in time of the parking state (i.e., a point in time when the gear transmission is set to the drive mode DM).

In some implementations, the parking data generator 123 may measure, as a parking time, an elapsed time from a turn-off point in time of the start of the car to a turn-on point in time of the start of the car.

In some implementations, the parking data generator 123 may classify the parking time as a long parking time or a short parking time and to generate the parking data PD. In some implementations, when the parking time is the long parking time, the parking data generator 123 may generate the parking data PD associated with the parking place.

For example, the parking data generator 123 may classify the parking time of the car as a very long parking time, a long parking time, a short parking time, or a very short parking time. For example, the very long parking time may mean the case where the parking time exceeds 10 hours, the long parking time may mean the case where the parking time exceeds 5 hours and is 10 hours or less, the short parking time may mean the case where the parking time exceeds 1 hour and is 5 hours or less, and the very short parking time may mean the case where the parking time is less than 1 hour. However, the present disclosure is not limited thereto. For example, it may be understood that a parking time classified by the parking data generator 123 as a long parking time or a short parking time or the number of parking times targeted for classification may be changed depending on settings of the user.

Referring to FIGS. 11 and 12 together, at a first point in time t1, the car may be parked at the first location L1 near the home and the start may be turned off. At a second point in time t2, the start of the car may be turned on, and the car may be in the driving state. In the time period from t3 to t4 and the time period from t5 to t6, while driving, the car may briefly stop and may be in the stop state. At a seventh point in time t7, the car may be parked at the second location L2 near the office and the start may be turned off. At an eighth point in time t8, the start of the car may be turned on, and the car may be in the driving state. Likewise, it may be understood that the car is in the parking state or the driving state at an arbitrary place.

When the parking time of the car at the first location L1 near the home (i.e., a time period Pt from t1 to t2) exceeds 10 hours, the parking data generator 123 may determine the parking time Pt at the first location L1 as a very long parking time and may generate first parking data PD1. The first parking data PD1 may include latitude information, longitude information, and a parking time associated with the first location L1 determined as a parking place.

When the parking time of the car at the second location L2 near the office (i.e., a time period Pt from t7 to t8) exceeds 5 hours and is less than 10 hours, the parking data generator 123 may determine the parking time Pt at the second location L2 as a long parking time and may generate second parking data PD2. The second parking data PD2 may include latitude information, longitude information, a parking time associated with the second location L2 determined as a second parking place.

When the car is in the driving state or the parking time of the car is less than 5 hours, the parking data generator 123 may not determine a parking place and may not generate the parking data PD; when the parking time of the car exceeds 5 hours, the parking data generator 123 may additionally generate third parking data PD3.

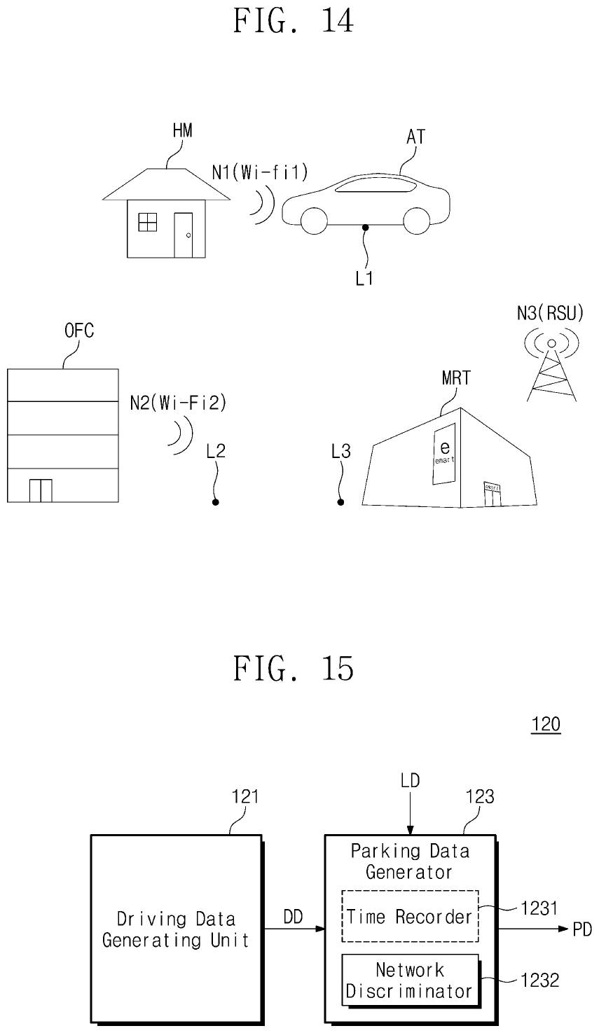

FIG. 13 is a diagram illustrating an example of a telecommunicating module. FIG. 14 is a diagram illustrating an example of a car receiving a network communication signal by a network receiver of FIG. 13. Below, a difference with the description given with reference to FIG. 8 will be mainly described.

Referring to FIGS. 13, the telecommunicating module 110 may include the GNSS receiver 111, a network receiver 112, and the location data generating unit 113. The GNSS receiver 111 may be substantially the same as the GNSS receiver 111 described with reference to FIG. 8.

The network receiver 112 may be configured to receive a network communication signal. For example, the network communication signal may include a Wi-Fi signal generated from a Wi-Fi terminal, a network signal generated from a road side unit (RSU), etc., but the present disclosure is not limited thereto. For example, the network communication signal may include various kinds of network signals for data exchange with the car.

The location data generating unit 113 may be configured to generate the location data LD of the car including real-time location information of the car based on network data ND of the network communication signal linked to the car and the car satellite information GD. For example, the location data LD of the car may include latitude and longitude information of the car and information about a network linked to the car.

Referring to FIG. 14, the car may be linked to a network communication signal corresponding to each place while sequentially moving the first location L1, the second location L2, and the third location L3. For example, at the first location L1, the car may be linked to first network information N1 (e.g., a first Wi-Fi) generated from a terminal installed in the home of the car driver; at the second location L2, the car may be linked to second network information N2 (e.g., a second Wi-Fi) generated from a terminal installed in the office of the car driver; at the third location L3, the car may be linked to third network information N3 generated from the road side unit installed on the road side near a mart.

As the car moves to the first to third locations L1, L2, and L3, the telecommunicating module 110 may determine the real-time location of the car based on the satellite communication signal from the satellite and may generate the location data LD of the car. For example, when the car arrives at the first location L1, the telecommunicating module 110 may generate the location data LD of the car including the latitude and longitude information of the first location L1 and the first network information N1. For example, when the car arrives at the second location L2, the telecommunicating module 110 may generate the location data LD of the car including the latitude and longitude information of the second location L2 and the second network information N2. For example, when the car arrives at the third location L3, the telecommunicating module 110 may generate the location data LD of the car including the latitude and longitude information of the third location L3 and the third network information N3.

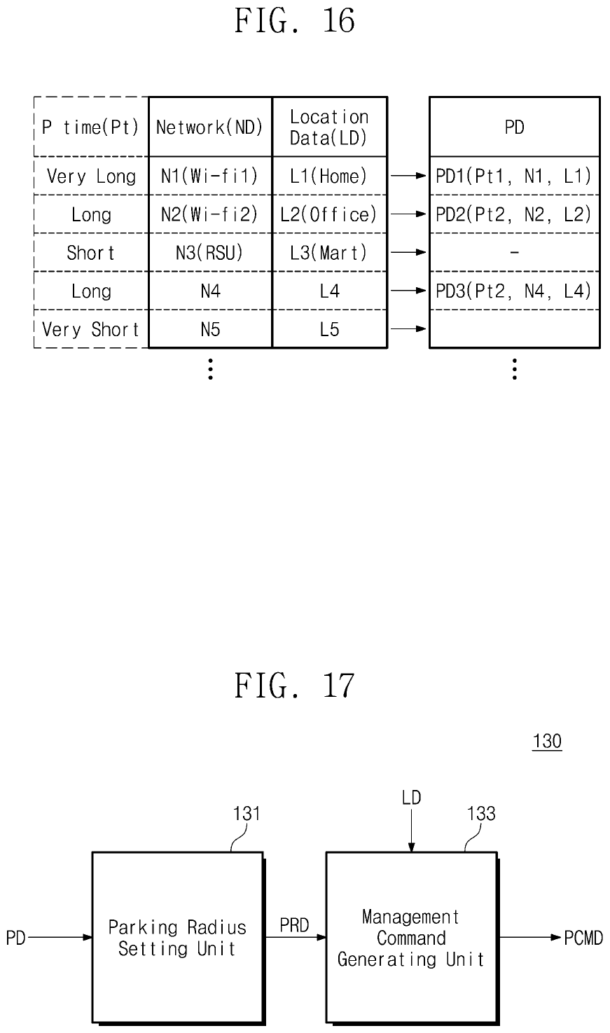

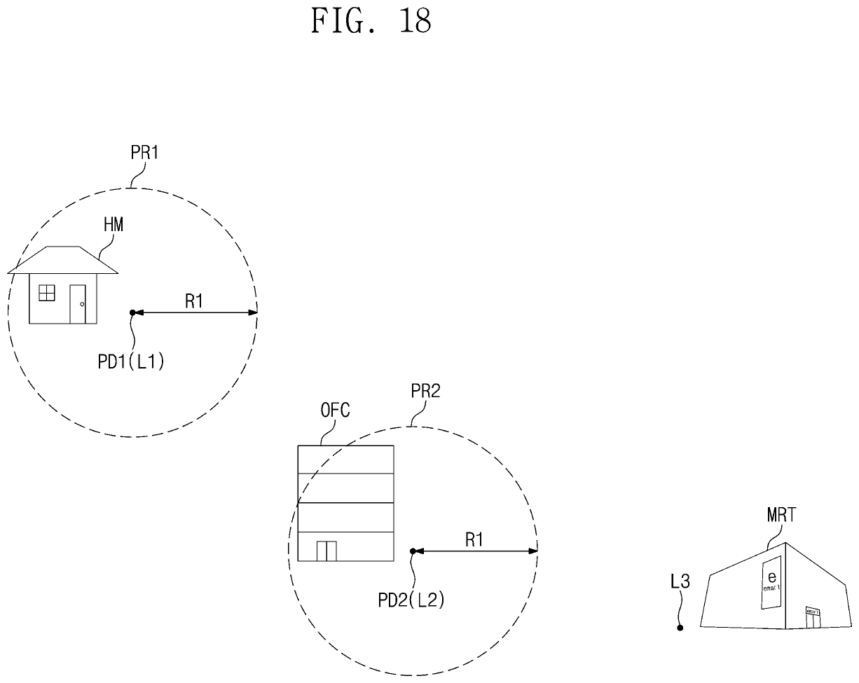

FIG. 15 is a diagram illustrating an example of a parking place setting module. FIG. 16 is a diagram for describing an example of an operation of a parking data generator of FIG. 15. Below, a difference with the description given with reference to FIG. 10 will be mainly described.

Referring to FIGS. 7 and 15, the parking place setting module 120 may include the driving data generating unit 121 and the parking data generator 123. The driving data generating unit 121 may be substantially the same as the driving data generating unit 121 described with reference to FIG. 10 and FIG. 11.

The parking data generator 123 may be configured to receive the driving data DD from the driving data generating unit 121 and to receive the location data LD of the car from the telecommunicating module 110. The parking data generator 123 may be configured to determine network information of a network communication signal, which is linked at a place where the car is in the parking state, based on the driving data DD and the location data LD of the car and to generate the parking data PD. In some implementations, the parking data PD may include latitude information, longitude information, and network information for each of a plurality of parking places. In some implementations, as described with reference to FIGS. 11 and 12, the parking data PD may further include information about a parking time.

In some implementations, the parking data generator 123 may include a network discriminator 1232 configured to discriminate information about a network linked to the car. The network discriminator 1232 may be configured to discriminate network information based on the information about the network linked to the car.

Referring to FIG. 16, when the car is linked to the first network information N1 of the first location L1, the parking data generator 123 may determine the first location L1 as a parking place and may generate the first parking data PD1. The first parking data PD1 may include the latitude and longitude information of the first location L1 determined as a parking place and the network information.

For example, when the car is linked to the second network information N2 of the second location L2, the parking data generator 123 may determine the second location L2 as a parking place and may generate the second parking data PD2. The second parking data PD2 may include the latitude and longitude information of the second location L2 determined as a parking place and the network information.

As another example, when the car is linked to the third network information N3 of the third location L3, the parking data generator 123 may not determine the third location L3 as a parking place and may not generate the parking data PD.

In some implementations, the parking data generator 123 may include the time recorder 1231 configured to measure a parking time of the car. When that the car is in a long parking state is determined together in consideration of the parking time, the parking data generator 123 may generate the parking data PD on a parking place associated with a linked network. How to classify a parking time as a long parking time or a short parking time is described with reference to FIG. 12.

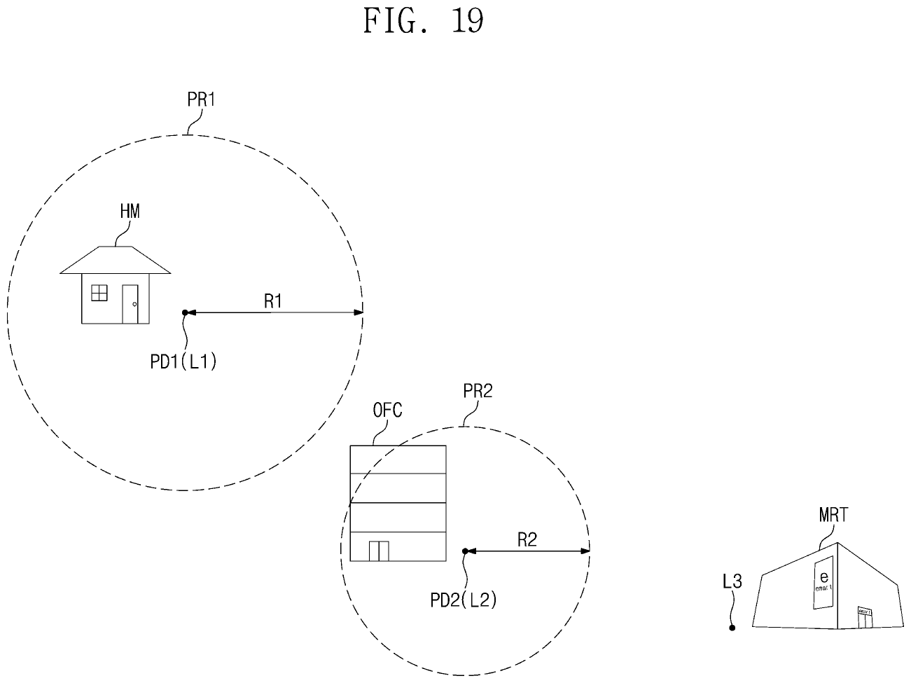

FIG. 17 is a diagram illustrating an example of a management execution module of FIG. 7. FIG. 18 is a diagram for describing an example of an operation of a parking radius setting unit of FIG. 17. FIG. 19 is a diagram for describing an example of an operation of a parking radius setting unit of FIG. 17. Below, a management execution module will be described with reference to FIG. 7 together.

Referring to FIGS. 7 and 17, the management execution module 130 may include a parking radius setting unit 131 and a management command generating unit 133.

The parking radius setting unit 131 may be configured to receive the parking data PD from the parking data storage space 203 of the storage 200. The parking radius setting unit 131 may be configured to set a parking radius with respect to a parking place based on the parking data PD and to generate parking radius data PRD. When data on a plurality of parking places are included in the parking data PD, the parking radius setting unit 131 may determine a parking radius for each parking place.

The parking radius may be used to define a region including a range of a given radius from a parking place based on the longitude information and the latitude information included in the parking data PD.

Referring to FIGS. 18 and 19, the parking data PD may include the first parking data PD1 including the longitude information and latitude information of the first location L1 and the second parking data PD2 including the longitude information and latitude information of the second location L2.

Referring to FIG. 18, in some implementations, the parking radius setting unit 131 may be configured to set a parking radius having the same radius for each parking place. For example, the parking radius setting unit 131 may set a region having a first radius R1 from the first location L1 to a first parking region PR1 and may set a region having the first radius R1 from the second location L2 to a second parking region PR2.

Referring to FIG. 19, in some implementations, the parking radius setting unit 131 may be configured to differently set a parking radius for each parking place. For example, the parking radius setting unit 131 may set a region having the first radius R1 from the first location L1 to a first parking region PR1 and may set a region having a second radius R2 from the second location L2 to a second parking region PR2.

In some implementations, a magnitude of the parking radius for each parking place may be set based on a parking time of the parking data PD. For example, when a parking time of the first location L1 included in first parking data PD1 is longer than a parking time of the second location L2 included in the second parking data PD2, the size of the first parking region PR1 may be larger than the size of the second parking region PR2.

In some implementations, a length of a radius of each parking place may be set based on the network information of the parking data PD and a network signal linked to the car. For example, in the case of the first location L1 corresponding to first network information included in the first parking data PD1, the first parking region PR1 may be set to have the first radius R1; in the case of the second location L2 corresponding to second network information included in the second parking data PD2, the second parking region PR2 may be set to have the second radius R2 smaller than the first radius R1.

The parking radius setting unit 131 may not set a parking radius with respect to a location whose information is not included in the parking data PD.

Returning to FIG. 17, the management command generating unit 133 may be configured to receive information about the parking radius generated by the parking radius setting unit 131 and to receive the location data LD of the car from the telecommunicating module 110. The management command generating unit 133 may be configured to generate the storage management command PCMD based on the parking radius data PRD and the location data LD of the car. For example, when the real-time location of the car based on the location data LD of the car is within the parking radius, the management command generating unit 133 may be configured to generate the storage management command PCMD.

A location (or a point in time) where (or when) the storage management command PCMD is generated by the management command generating unit 133 while the car approaches a parking place may change depending on a magnitude of a parking radius.

In some implementations, when the parking time of the first location L1 included in first parking data PD1 is longer than the parking time of the second location L2 included in the second parking data PD2, the size of the first parking region PR1 may be larger than the size of the second parking region PR2. As such, a distance from the first location L1 to a location where the storage management command PCMD is generated by the management command generating unit 133 as the car approaches the first location L1 may be longer than a distance from the second location L2 to a location where the storage management command PCMD is generated by the management command generating unit 133 as the car approaches the second location L2. In other words, a point in time when the storage management command PCMD is generated in a case where the car approaches the first location L1 may be advanced with respect to a point in time when the storage management command PCMD is generated in a case where the car approaches the second location L2.

According to the present disclosure, a magnitude of a parking radius may be differently set for each parking place; in this case, a location (or a point in time) where (or when) a memory management operation of storage is performed in a case where the car approaches each parking place may be optimized.

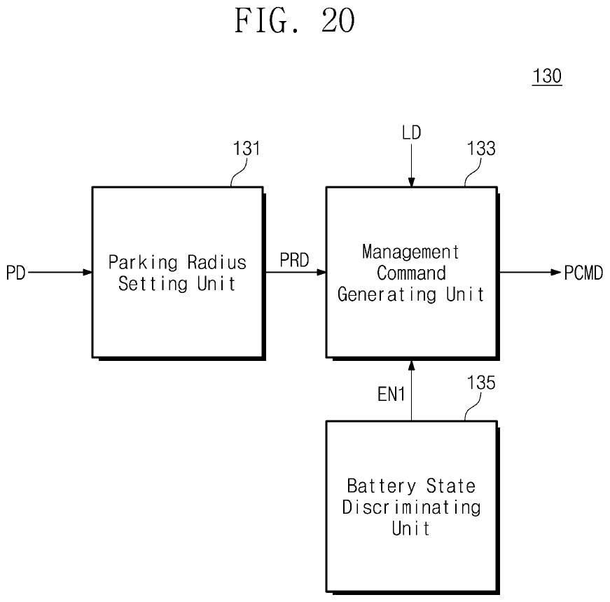

FIG. 20 is a diagram illustrating an example of a management execution module of FIG. 7. Below, a difference with the description given with reference to FIG. 17 will be mainly described.

Referring to FIG. 20, the management execution module 130 may include the parking radius setting unit 131, the management command generating unit 133, and a battery state discriminating unit 135. The parking radius setting unit 131 may be substantially the same as the parking radius setting unit 131 described with reference to FIG. 17.

The management command generating unit 133 may be configured to receive a first enable signal EN1 from the battery state discriminating unit 135. When the first enable signal EN1 is activated, the management command generating unit 133 may generate the storage management command PCMD described with reference to FIGS. 17 to 19. When the first enable signal EN1 is deactivated, the management command generating unit 133 may not generate the storage management command PCMD.

The battery state discriminating unit 135 may be configured to generate the first enable signal EN1 based on a charging level of a battery of the car. The battery state discriminating unit 135 may obtain information about the charging level of the battery by using a battery management system (BMS) of the car.

In some implementations, when the charging level of the battery of the car is smaller than or equal to a threshold value, the battery state discriminating unit 135 may activate the first enable signal EN1. When the charging level of the battery of the car is sufficiently high (e.g., is greater than or equal to the threshold value), the memory management operation of the storage 200 may be performed even in the parking state by using the battery management system of the car. Accordingly, according to the present disclosure, when the charging level of the battery of the car decreases to the threshold value or less, the memory management operation for preventing the storage 200 from deteriorating may be performed based on the parking data PD of the car, before and after the start of the car is turned off.

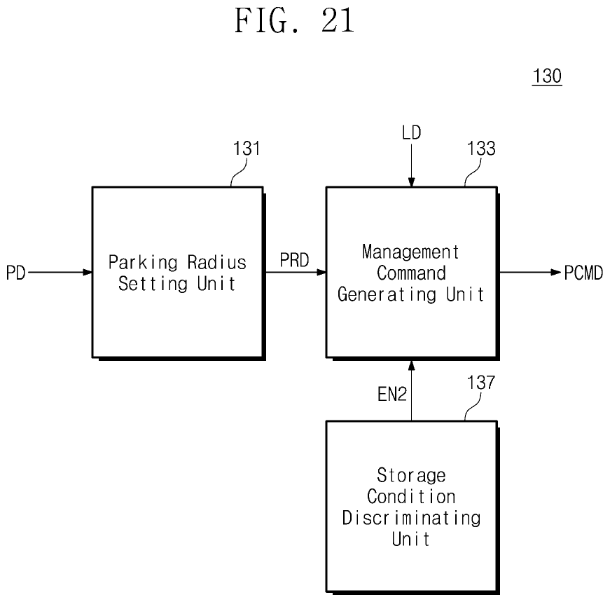

FIG. 21 is a diagram illustrating an example of a management execution module of FIG. 7. Below, a difference with the description given with reference to FIG. 17 will be mainly described.

Referring to FIG. 21, the management execution module 130 may include the parking radius setting unit 131, the management command generating unit 133, and a storage condition discriminating unit 137. The parking radius setting unit 131 may be substantially the same as the parking radius setting unit 131 described with reference to FIG. 17.

The management command generating unit 133 may be configured to receive a second enable signal EN2 from the storage condition discriminating unit 137. When the second enable signal EN2 is activated, the management command generating unit 133 may generate the storage management command PCMD described with reference to FIGS. 17 to 19. When the second enable signal EN2 is deactivated, the management command generating unit 133 may not generate the storage management command PCMD.

The storage condition discriminating unit 137 may be configured to generate the second enable signal EN2 based on information about a condition of the storage 200 in the car. For example, the storage condition discriminating unit 137 may measure a temperature of the storage 200 and may determine a condition of the storage 200.

In some implementations, when the temperature of the storage 200 is greater than or equal to a threshold value, the storage condition discriminating unit 137 may activate the second enable signal EN2. When the temperature of the storage 200 is excessively high, the data of the storage 200 may sharply deteriorate, and the probability that an error occurs may increase.

In some implementations, when the temperature of the storage 200 is greater than or equal to the threshold value, the storage condition discriminating unit 137 may activate the second enable signal EN2. Even when the temperature of the storage 200 is excessively low, the data of the storage 200 may sharply deteriorate, and the probability that an error occurs may increase.

Accordingly, according to the present disclosure, when the temperature of the storage 200 is excessively high or low, the memory management operation for preventing the storage 200 from deteriorating may be performed based on the parking data PD of the car, before and after the start of the car is turned off.

FIG. 22 is a diagram illustrating an example of storage of FIGS. 6 and 7.

Referring to FIG. 22, the storage 200 may include a memory controller 210 and a nonvolatile memory device 220. The nonvolatile memory device 220 may include a plurality of memory blocks. For example, the nonvolatile memory device 220 may be substantially the same as that described with reference to FIGS. 2 and 3.

The memory controller 210 may control the nonvolatile memory device 220 under control of an external device such as a host. For example, depending on an external request, the memory controller 210 may write data in the nonvolatile memory device 220 or may read data stored in the nonvolatile memory device 220. To this end, the memory controller 210 may transmit the address ADDR, the command CMD, and the control signal CTRL to the nonvolatile memory device 220.

The memory controller 210 may be configured to receive the storage management command PCMD from the storage manager 100. The memory controller 210 may include a retention manager 211. The retention manager 211 may be configured to perform the memory management operation with respect to the nonvolatile memory device 220 based on the storage management command PCMD. For example, the memory management operation may include a data refresh operation, a wear leveling operation, a garbage collection operation, etc.

In some implementations, the storage manager 100 may include an erase table 213 configured to store the number of erase operations performed with respect to the nonvolatile memory device 220. The erase table 213 may be configured to store the number of erase operations (or an erase count) for each memory block. For example, the erase table 213 may store a first erase count of a first memory block, a second erase count of a second memory block, and a z-th erase count of a z-th memory block.

In some implementations, the retention manager 211 may be configured to perform the memory management operation based on the erase counts stored in the erase table 213. For example, when the storage management command PCMD is received, the retention manager 211 may perform the memory management operations with respect to memory blocks in a descending order from greatest to smallest erase counts.

In some implementations, the storage manager 100 may include an access table 214 configured to store the number of accesses performed with respect to the nonvolatile memory device 220. The access table 214 may be configured to store the number of accesses (or an access count) for each memory block. For example, the access table 214 may store a first access count of the first memory block, a second access count of the second memory block, and a z-th access count of the z-th memory block.

In some implementations, the retention manager 211 may be configured to perform the memory management operation based on the access counts stored in the access table 214. For example, when the storage management command PCMD is received, the retention manager 211 may perform the memory management operations with respect to memory blocks in an ascending order from smallest to greatest access counts.

In some implementations, the storage manager 100 may include an error correction code (ECC) engine 215. The ECC engine 215 may correct an error of data damaged in the nonvolatile memory device 220. For example, the ECC engine 215 may perform an operation for detecting and correcting an error of data read from the nonvolatile memory device 220.

Depending on a request of the retention manager 211, the ECC engine 215 may count the number of correctable bits of the data read from the nonvolatile memory device 220 or may count the number of operations repeatedly performed for correction. The retention manager 211 may perform the memory management operation on the nonvolatile memory device 220, based on a counting value obtained by counting the number of correctable bits or the number of operations repeatedly performed for correction.

For example, when the storage management command PCMD is received, the retention manager 211 may perform the memory management operations with respect to memory blocks in a descending order from greatest to smallest counting values.

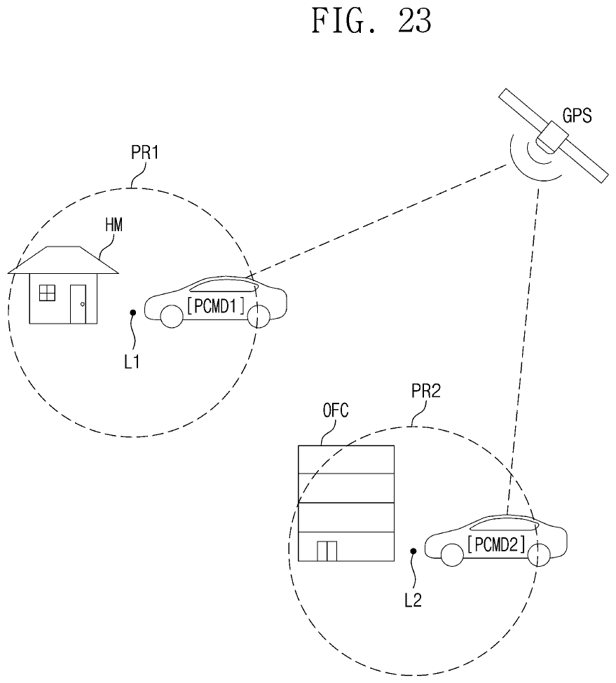

Below, an example of a memory management operation will be described with reference to FIGS. 23 to 26.

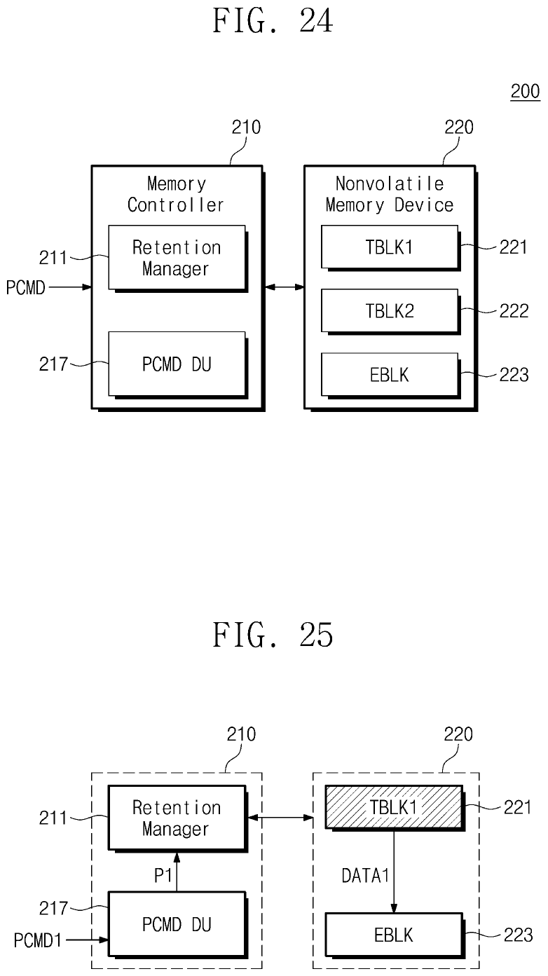

FIG. 23 is a diagram for describing an example of a memory management operation according to a storage management command. FIG. 24 is a diagram illustrating an example of storage of FIG. 22. Below, a memory management operation according to a storage management command will be described in detail with reference to FIGS. 17 to 19 together.

As described with reference to FIG. 17, the management execution module 130 may generate the storage management command PCMD based on the location data LD of the car and the parking radius data PRD. The storage management command PCMD may include a plurality of storage management commands respectively corresponding to a plurality of parking radiuses.

Referring to FIG. 23, the management execution module 130 may generate a first storage management command PCMD1 when the location of the car is within the first parking region PR1 and may generate a second storage management command PCMD2 when the location of the car is within the second parking region PR2.

Referring to FIG. 24, the memory controller 210 of the storage 200 may include the retention manager 211 and a management command decoder 217. The management command decoder 217 may be configured to decode the storage management command PCMD. The retention manager 211 may perform the memory management operation on the storage 200 based on a decoding result of the management command decoder 217. For example, the memory management operation may be a data refresh operation.

The nonvolatile memory device 220 may be configured to store various kinds of data that are used in the driving of the car. In some implementations, the nonvolatile memory device 220 may store specific data in a specific memory block.

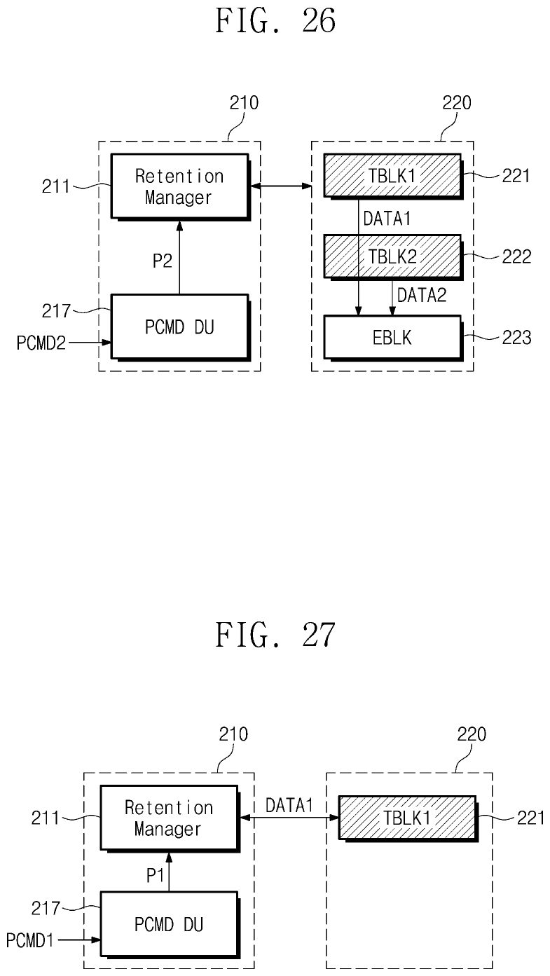

The nonvolatile memory device 220 may include a first target block 221, a second target block 222, and an empty block 223. The first target block 221 may store first data DATA1 (refer to FIG. 25), and the second target block 222 may store second data DATA2 (refer to FIG. 26).

In some implementations, the first data DATA1 may include information of high importance associated with the driving of the car, the safety of the car, etc. For example, the first data DATA1 may include driving information of the car, information about car safety such as an ADAS (Advanced Driver Assistance System) or an ASIL (Automotive Safety Integrity Level), infotainment information, information about an operating system program.

In some implementations, the second data DATA2 may include information of low importance not directly associated with the driving of the car, the safety of the car, etc. For example, the second data DATA2 may include information that is necessary to drive the memory controller 210 and to perform the memory management operation on the storage 200. The empty block 223 may mean a redundant memory block capable of storing data.

FIG. 25 is an example diagram illustrating an example of a first memory management operation performed depending on a first storage management command. FIG. 26 is an example diagram illustrating an example of a second memory management operation performed depending on a second storage management command.

Referring to FIG. 25, when the management command decoder 217 receives the first storage management command PCMD1, the retention manager 211 may perform a first memory management operation with respect to the first target block 221 where the first data DATA1 are stored. For example, the retention manager 211 may copy the first data DATA1 stored in the first target block 221 to the empty block 223 and may perform the erase operation with respect to the first target block 221.

Referring to FIG. 26, when the management command decoder 217 receives the second storage management command PCMD2, the retention manager 211 may perform a second memory management operation with respect to the first target block 221 where the first data DATA1 are stored and the second target block 222 where the second data DATA2 are stored. For example, the retention manager 211 may copy the first data DATA1 stored in the first target block 221 and the second data DATA2 stored in the second target block 222 to the empty block 223 and may perform the erase operation with respect to the first target block 221 and the second target block 222.

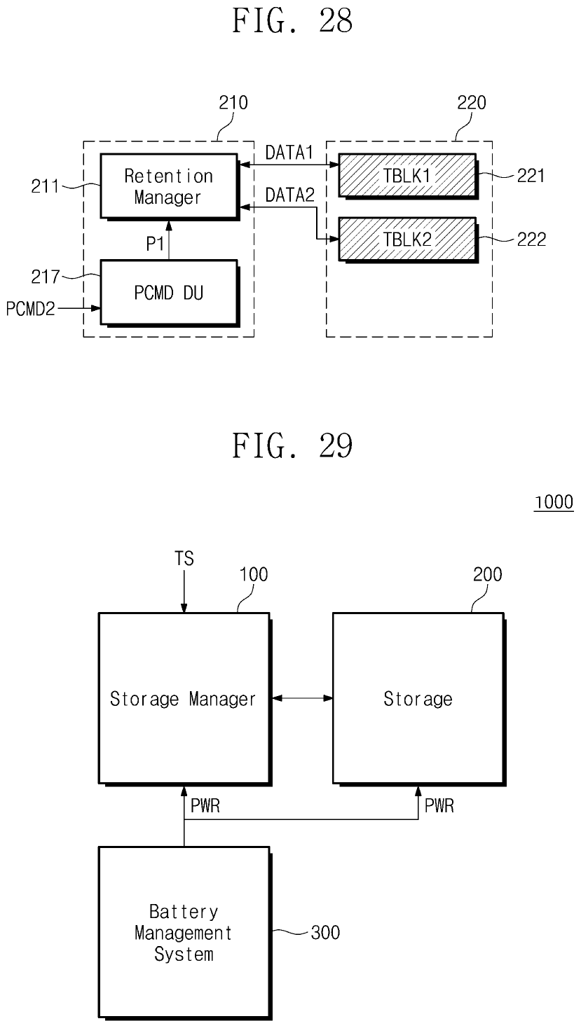

FIG. 27 is a diagram illustrating another example of a first memory management operation performed depending on a first storage management command. FIG. 28 is a diagram illustrating another example of a second memory management operation performed depending on a second storage management command.

Referring to FIG. 27, when the management command decoder 217 receives the first storage management command PCMD1, the retention manager 211 may perform the first memory management operation with respect to the first target block 221 where the first data DATA1 are stored. For example, the retention manager 211 may perform the data refresh operation with respect to the first target block 221. For example, the retention manager 211 may temporarily store the first data DATA1 in a buffer, may erase the first target block 221, and may again write the first data DATA1 stored in the buffer in the first target block 221.

Referring to FIG. 28, when the management command decoder 217 receives the second storage management command PCMD2, the retention manager 211 may perform the second memory management operation with respect to the first target block 221 where the first data DATA1 are stored and the second target block 222 where the second data DATA2 are stored. For example, the retention manager 211 may perform the data refresh operation with respect to the first target block 221 and the second target block 222. For example, the retention manager 211 may temporarily store the first data DATA1 and the second data DATA2 in the buffer, may erase the first target block 221 and the second target block 222, and may again write the first data DATA1 and the second data DATA2 stored in the buffer in the first target block 221 and the second target block 222, respectively.

However, the present disclosure is not limited to the above description. For example, the management command decoder 217 may perform the second memory management operation when the first storage management command PCMD1 is received and may perform the first memory management operation when the second storage management command PCMD2 is received. That is, it may be understood that the memory management operation corresponding to the storage management command PCMD may be changed depending on settings of the user.

FIG. 29 is a diagram illustrating another example of a storage management system. Below, a difference with the description given with reference to FIGS. 6 to 28 will be mainly described.

Referring to FIG. 29, the car storage management system 1000 may include the storage manager 100, the storage 200, and a battery management system 300. Configurations and operations of the storage manager 100 and the storage 200 are substantially the same as those described with reference to FIGS. 6 to 28.

The battery management system 300 may be configured to access and manage a battery provided inside the car. The battery management system 300 may be configured to supply a power PWR of the battery to the storage manager 100 and the storage 200. In some implementations, the battery management system 300 may be configured to supply the power PWR to the storage manager 100 and the storage 200 during a given time even immediately after the start of the car is turned off. For example, the battery management system 300 may be configured to supply the power PWR to the storage manager 100 and the storage 200 for 10 to 20 seconds even immediately after the start of the car is turned off. As such, even immediately after the start of the car is turned off, the storage manager 100 may perform the memory management operation with respect to the storage 200.

According to some implementations of the present disclosure, a storage management system for preventing storage deterioration through a memory management operation on storage provided inside a car is provided.

While this specification contains many specific implementation details, these should not be construed as limitations on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. A storage management system comprising:
a storage manager configured to generate a storage management command based on location data of a car and parking data, the location data of the car including information about a real-time location of the car and the parking data including information about a parking place; and
a storage inside the car, the storage including a nonvolatile memory device,
wherein the storage is configured to, based on the storage management command, perform a memory management operation that prevents data loss of the nonvolatile memory device.

2. The storage management system of claim 1, wherein the storage manager includes:
a telecommunicating circuit configured to receive a telecommunication signal and to generate the location data of the car;
a parking place setting circuit configured to determine the parking place based on the location data of the car and to generate the parking data; and
a management execution circuit configured to generate the storage management command based on the location data of the car and the parking data.

3. The storage management system of claim 2, wherein the telecommunication signal includes a satellite communication signal, and
wherein the parking place setting circuit is configured to determine the parking place based on satellite communication information, a driving condition of the car, and a parking time.

4. The storage management system of claim 3, wherein the telecommunicating circuit includes:
a Global Navigation Satellite System (GNSS) receiver configured to receive the satellite communication signal and to transfer satellite information; and
a location data generating circuit configured to generate the location data of the car based on the satellite information, and
wherein the location data of the car includes latitude information and longitude information of the car.

5. The storage management system of claim 4, wherein the parking place setting circuit includes:
a driving data generating circuit configured to determine the driving condition of the car as one of a parking state, a driving state, and a stop state and to generate driving data; and
a parking data generator configured to determine, based on the driving data and the location data, the parking time at a location at which the car is in the parking state, and to generate the parking data.

6. The storage management system of claim 4, wherein the telecommunicating circuit includes:
a network receiver configured to receive a network communication signal, and
wherein the location data generating circuit is configured to generate the location data of the car based on the satellite information and network information of the network communication signal linked to the car.

7. The storage management system of claim 6, wherein the parking place setting circuit includes:
a driving data generating circuit configured to determine the driving condition of the car as one of a parking state, a driving state, and a stop state and to generate driving data; and
a parking data generator configured to determine, based on the driving data and the location data, the network information of the network communication signal linked at a location at which the car is in the parking state, and to generate the parking data.

8. The storage management system of claim 4, wherein the management execution circuit includes:
a parking radius setting circuit configured to set a parking radius with respect to the parking place based on the parking data and to generate parking radius data; and
a management command generating circuit,
wherein, based on the real-time location of the car being within the parking radius, the management command generating circuit is configured to generate the storage management command based on the parking radius data and the location data of the car.

9. The storage management system of claim 8, wherein the parking data include information about a plurality of locations and a plurality of parking times corresponding to the plurality of locations, respectively, and
wherein the parking radius setting circuit is configured to set a plurality of parking radiuses based on the plurality of parking times.

10. The storage management system of claim 9, wherein the parking data include a first parking time of a first location and a second parking time of a second location,
wherein the parking radius setting circuit is configured to, based on the first parking time being longer than the second parking time, set a region having a first radius from the first location as a first parking region and set a region having a second radius from the second location as a second parking region, and
wherein a size of the first parking region is larger than a size of the second parking region.

11. The storage management system of claim 8, wherein the management execution circuit includes:
a battery state discriminating circuit configured to generate a first enable signal based on a charging level of a battery of the car, and
wherein the management command generating circuit is configured to, based on the first enable signal being activated, generate the storage management command.

12. The storage management system of claim 8, wherein the management execution circuit includes:
a storage condition discriminating circuit configured to generate a second enable signal based on information about a condition of the storage, and
wherein the management command generating circuit is configured to, based on the second enable signal being activated, generate the storage management command.

13. The storage management system of claim 1, wherein the storage includes:
a memory controller configured to perform the memory management operation with respect to the nonvolatile memory device based on the storage management command, and wherein the memory management operation includes a data refresh operation.

14. A storage management system comprising:
a storage manager configured to generate a storage management command based on location data of a car and parking data, the location data of the car including information about a real-time location of the car and the parking data including information about a parking place; and
a storage inside the car, the storage including a nonvolatile memory device,
wherein the parking place includes a first location and a second location,
wherein the storage manager is configured to set a first parking region of the first location and a second parking region of the second location,
wherein, based on a plurality of communication signals, the storage manager is configured to:
generate a first storage management command when a location of the car is within the first parking region; and
generate a second storage management command when the location of the car is within the second parking region, and
wherein the storage is configured to:
perform a first memory management operation based on the first storage management command; and
perform a second memory management operation based on the second storage management command.

15. The storage management system of claim 14, wherein the parking data include a first parking time of the first location and a second parking time of the second location,
wherein the storage manager is configured to, based on the first parking time being longer than the second parking time, set a region having a first radius from the first location as the first parking region and set a region having a second radius from the second location as the second parking region, and
wherein a size of the first parking region is larger than a size of the second parking region.

16. The storage management system of claim 15, wherein the storage includes:
a retention manager configured to perform the first memory management operation based on the first storage management command,
wherein the nonvolatile memory device includes a plurality of memory blocks,
wherein the plurality of memory blocks include a first target block where first data are stored and an empty block, and
wherein the retention manager is configured to, based on the first memory management operation being performed, copy the first data stored in the first target block to the empty block and perform an erase operation with respect to the first target block.

17. The storage management system of claim 15, wherein the storage includes:
a retention manager configured to perform the second memory management operation based on the second storage management command,
wherein the nonvolatile memory device includes a plurality of memory blocks,
wherein the plurality of memory blocks include a first target block where first data are stored, a second target block where second data are stored, and an empty block, and
wherein the retention manager is configured to, based on the second memory management operation being performed, copy the first data stored in the first target block and the second data stored in the second target block to the empty block and perform an erase operation with respect to the first target block and the second target block.

18. The storage management system of claim 17, wherein the first data include driving data of the car, infotainment information of the car, or information about an operating system program of the car, and
wherein the second data include information for performing the second memory management operation.

19. A storage management system comprising:
a storage manager configured to receive a telecommunication signal, to set a parking place based on the telecommunication signal and a driving condition of a car, and to generate parking data; and
a storage including a parking data storage space, the parking data storage space configured to store the parking data generated by the storage manager,
wherein the storage manager is configured to:
receive the parking data from the parking data storage space; and
generate a storage management command based on the telecommunication signal and the parking data, and
wherein the storage is configured to perform a memory management operation that prevents data loss based on the storage management command.

20. The storage management system of claim 19, comprising:
a battery management system configured to use a battery inside the car to provide a power to the storage manager and the storage,
wherein the battery management system is configured to provide the power for 10 to 20 seconds immediately after the car is turned off.
